(19) United States
(12) Patent Application Publication
(10) Pub. No.: US 2023/0148193 A1
(43) Pub. Date: May 11, 2023

(54) Device and Method for Manufacturing Products

(71) Applicant: Integrated Mechanization Solutions Holding B.V., Almelo (NL)

(72) Inventors: Gijsbert Johannes Michael Rolff, Borne (NL); Wouter Hendrik Cornelis Spoorendonk, Deventer (NL); Martijn Johannes Bouwhuis, Broekland (NL)

(21) Appl. No.: 17/918,602

(22) PCT Filed: Apr. 9, 2021
(86) PCT No.: PCT/NL2021/000003

§ 371 Date: Oct. 13, 2022

(30) Foreign Application Priority Data
Apr. 14, 2020 (NL) 1043633

(51) Int. Cl. H04N 23/55

(52) U.S. Cl. CPC H04N 23/55; B23K 26/21

(57) ABSTRACT

A device for manufacturing products, which include a first component and a second component mutually connected in a determined desired relative position. The device includes a plurality of assemblies assembly which each include a first holder for holding a first component; a second holder for holding a second component; and a couple for mutually coupling the first holder and the second holder such that they can move relative to each other within a determined range to a relative position in which a first component held by the first holder and a second component held by the second holder are in the determined desired relative position. The holders can be temporarily secured and fixed in the relative position. The device also includes a first actuator for moving the holders relative to each other within the determined range to the relative position; and a connector for mutually connecting the first component and the second component in the determined desired relative position.

### CROSS-REFERENCE TO RELATED APPLICATIONS

This application is the United States national phase of International Application No. PCT/NL2021/000003 filed Apr. 9, 2021, and claims priority to The Netherlands Patent Application No. 1043633 filed Apr. 14, 2020, the disclosures of which are hereby incorporated by reference in their entirety.

### BACKGROUND OF THE INVENTION

### Field of the Invention

The invention relates to a device for manufacturing products, each product comprising a first component and a second component mutually connected in a determined desired relative position with an accuracy to within less than 50 micrometres. The invention also relates to a method for manufacturing such products.

### Description of Related Art

Known is a product comprising two components which are mutually connected, for instance by means of gluing, welding, soldering or connection by means of a laser technique, in a determined desired relative position with a high precision. For manufacture of such a product the two components must be mutually aligned very accurately and then be secured and fixed in the aligned relative position during mutual connection of the two components. Many examples hereof can be found in patent documents with (IPC/CPC) classification code B23P19/10, for instance CN108296751A.

In a production line for such products the mutual alignment and the securing and fixing in the aligned relative position during the mutual connecting of the two components takes place by means of actuator. During the mutual connecting of the two components the actuator is thus unavailable for mutually aligning a subsequent pair of components of a subsequent product.

If the mutual alignment plus mutual connection, for instance the drying of a glue, takes more time than any of the other processing steps, this production step determines the production time per product. In order to reduce the production time per product this production step must then be multiplied. The costs of purchasing, setting up, using and maintaining the production line however increase here, especially in the case of a relatively expensive actuator, such as an active alignment actuator for mutually aligning the two components with a high accuracy, and the device also takes up more space.

The present invention now provides a solution for the stated problems, and in addition has still more advantages.

### SUMMARY OF THE INVENTION

The invention provides a device of the stated type, characterized in that the device comprises:
a plurality of assemblies, each assembly comprising:
   a first holder configured and suitable for holding a first component;
   a second holder configured and suitable for holding a second component; and
   coupling means configured and suitable for mutually coupling the first holder and the second holder such that the first holder and the second holder can move relative to each other within a determined range to a relative position in which a first component held by the first holder and a second component held by the second holder are in the determined desired relative position and the first holder and the second holder can then be temporarily secured and fixed in the relative position;
a first actuator for moving the first holder and the second holder relative to each other within the determined range to the relative position; and
connecting means configured and suitable for mutually connecting the first component and the second component in the determined desired relative position.

The invention also provides a method of the stated type, characterized in that the method comprises the steps of:
holding a first component by means of a first holder provided for this purpose;
holding a second component by means of a second holder provided for this purpose;
mutually coupling the first holder and the second holder by means of coupling means provided for this purpose, such that the first holder and the second holder can move relative to each other within a determined range to a relative position in which the first component held by the first holder and the second component held by the second holder are in the determined desired relative position;
moving the first holder and the second holder relative to each other within the determined range to the relative position by means of a first actuator provided for this purpose;
temporarily securing and fixing the first holder and the second holder in the relative position by means of the coupling means; and
mutually connecting the first component and the second component in the determined desired relative position by means of connecting means provided for this purpose.

The first actuator is thus used only for the relative movement of the two holders to the relative position. The coupling means secure and fix the two holders in the relative position during the mutual connecting of the two components. The production time per product can thus be reduced, and the choice of connecting technique can also be expanded. In the context of the invention ‘moving’ is understood to mean ‘moving with one or more degrees of freedom of movement’. In the context of the invention ‘securing and fixing’ is understood to mean ‘limiting the possibility of movement by one or more degrees of freedom of movement’. The relevant action can optionally take place in steps, per degree of freedom of movement or per multiple degrees of freedom of movement.

### BRIEF DESCRIPTION OF THE DRAWINGS

The invention is further elucidated hereinbelow on the basis of exemplary embodiments. More or less schematically in the drawings:

FIG. 1 shows a perspective top view of an assembly forming part of a device according to the invention; and

FIG. 2 shows a device and method according to the invention.

### DESCRIPTION OF THE INVENTION

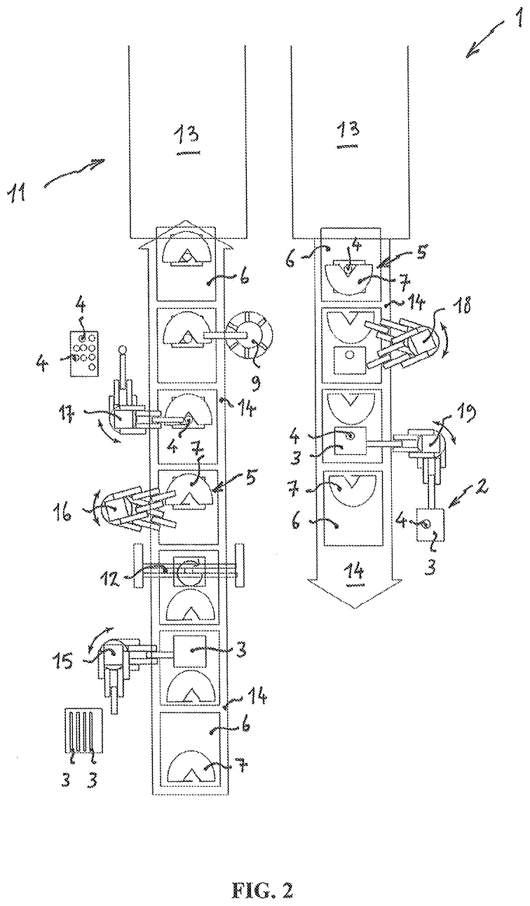

The exemplary embodiment of a device (1) according to the invention shown in FIG. 2 is here a production line for manufacturing products (2), here micro-cameras, each comprising a first component (3) of an optical nature, here a PCB /image sensor, and a second component (4) of an optical nature, here a lens, mutually connected, here by means of gluing, in a determined desired relative position (A) with an accuracy to within less than 10 micrometres. The production line (1) comprises here a conveyor belt (14) whereby first holders (6) are transported, here in serial and cyclical manner, along a number of workstations. The production line (1) here also comprises a glue dispenser (12) and a workstation (13) for curing the glue, here by heating (oven) or by means of UV light, for the purpose of mutually connecting a PCB/image sensor (3) and a lens (4) in the determined desired relative position (A).

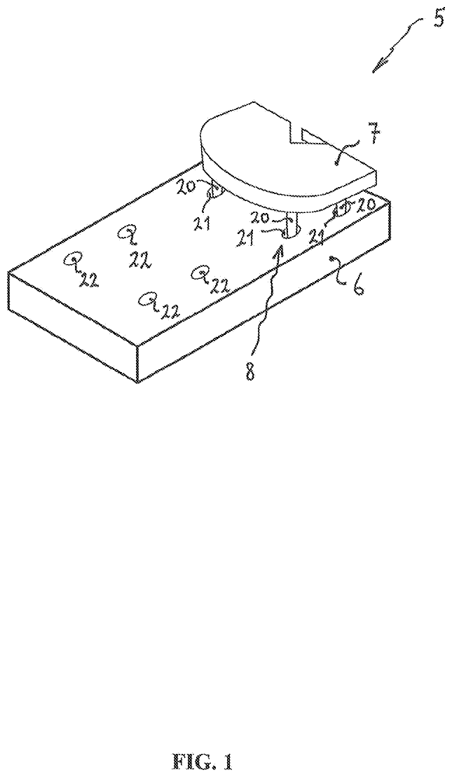

The production line (1) also comprises a number of assemblies (5), each comprising, see FIG. 1, a first holder (6) for holding a PCB/image sensor, a second holder (7) for holding a lens (4), and coupling means (8), here comprising four coupling members (20), for mutually coupling the first holder (6) and the second holder (7) such that the first holder (6) and the second holder (7) can be mutually aligned within a determined range, ie move to a relative position (B) in which a PCB/image sensor (3) held by the first holder (6) and a lens (4) held by the second holder (7) are in the determined desired relative position (A). In other embodiments the coupling means can for instance also be of pneumatic nature, hydraulic nature (cylinders) or otherwise mechanical nature (rod assembly). The production line (1) also comprises a first actuator (9), here an active alignment actuator for mutual alignment of a first holder (6) and a second holder (7), and thereby a PCB/image sensor (3) and a lenses (4). The first holder (6) and the second holder (7) can also be secured and fixed in the relative position (B) by means of the coupling means (8). For this purpose the coupling means (8) here also comprises four securing members (not shown) which can engage on the four coupling members 20 and thus secure and fix them in a determined position. In the given example all four coupling members (20) are secured in the first holder (6) simultaneously by means of the four securing members coupled mechanically to each other for this purpose. In another embodiment this can for instance also be done per coupling member (20) and/or per degree of freedom of movement and/or in a plurality of successive workstations. A first holder (6) and a second holder (7) can thus be mutually aligned and be secured and fixed in the relative position (B), optionally in steps, optionally per degree of freedom of movement, optionally in a plurality of workstations.

The four coupling members (20) are here fixedly connected, each with a first outer end, to a second holder (7). A first holder (6) is here provided with four first receiving spaces (21), each for receiving, here by means of sliding therein, a second outer end of a coupling member (20). The first holder (6) and the second holder (7) can thus be coupled to each other, here releasably, for relative movement within a determined range. The first holder (6) here also comprises four second receiving spaces (22), each once again for receiving, here once again by means of sliding therein, a second outer end of a coupling member (20). The first holder (6) and the second holder (7) can thus be coupled to each other, here once again releasably, in a temporary relative ‘parked position’.

The exemplary embodiment of a method according to the invention shown schematically in FIG. 2 includes the following steps. A PCB/image sensor (3) is placed on a first holder (6) by means of a second actuator (15), on which first holder (6) a second holder (7) is ‘parked’. A quantity of glue is then applied to the PCB/image sensor (3) by means of the glue dispenser (12). The second holder (7) is then placed from the ‘parked position’ onto the first holder (6) by means of a third actuator (16), wherein the second outer ends of the four coupling members (20) slide into the first receiving spaces (21). A lens (4) is then placed on the second holder (7) by means of a fourth actuator (17).

In a subsequent workstation the second holder (7) is aligned (B) relative to the first holder (6) by means of the first actuator (9), and the lens (4) is thereby aligned (A) relative to the PCB/ image sensor (3). The securing members are then made to engage on the coupling members (20), such that the holders (6, 7) are secured and fixed in the relative position (B), and the lens (4) and the PCB/image sensor (3) thereby in the determined desired relative position (A). The assembly (5), with the lens (4) and PCB/image sensor (3), is then transported on to the workstation (13) for curing of the glue. The first actuator (9) is then once again available for mutual alignment of a subsequent set of holders (6,7) or lens (4) and PCB/image sensor (3).

After leaving the workstation (13) for curing of the glue, the coupling members (20) are ‘released’ by the securing members, and the second holder (7) is lifted off the first holder (6) by means of a fifth actuator (18) and ‘parked’ thereon. The product (2) is then removed from the first holder (6) by means of a sixth actuator (19), after which the first holder (6) with the second holder (7) ‘parked’ thereon is transported by means of the conveyor belt (14) to the workstation with the second actuator (15) for a subsequent production cycle.

The alignment by the first actuator (9) takes 5 seconds here, the curing of the glue 20 seconds, and each of the remaining production steps less than 5 seconds. In a known serial production line, in which the first actuator (9) is also used for securing and fixing of the two components (3,4) during curing of the glue, the production time per product then amounts to 25 seconds(=the time for the alignment plus the time for curing of the glue). In order to reduce the production time per product the production step comprising the alignment plus the curing of the glue can be multiplied, although a plurality of (expensive) first actuators must then be utilized, which makes the production line and the use and maintenance thereof much more expensive. The device then also takes up more space.

The workstation (13) for curing the glue is now dimensioned here such that four assemblies (5) can be present therein at the same time. By using, as according to the invention, the first actuator (9) only for the relative movement of the two holders (6,7) to the relative position (B), and using the coupling means (8) or the securing members for securing and fixing the holders (6,7) in the relative position (B), during curing of the glue, the production time per product has here been reduced to 5 seconds(=the time for alignment), all this without multiplying and without employing other (expensive) first actuators.

In another embodiment the mutual connecting of the two components can comprise a different connecting technique, for instance welding, soldering or connection by means of a laser technique. Because the connecting is performed spatially separated from the alignment, there are more options for placing the equipment required for the connecting, and the choice of connecting technique is thereby expanded.

According to the invention, an assembly (5) can also comprise an energy buffer (not shown) for storing energy and supplying energy to the coupling means (8) or the securing members, for instance in the form of an electrical accumulator, although the energy buffer can for instance also be of a magnetic nature, pneumatic nature (pressure vessel), hydraulic nature or mechanical nature (spring force). The assembly (5) thus has its own independent energy source, separate from ‘the fixed world’.

It will be apparent that the invention is not limited to the given exemplary embodiments but that various variants and combinations obvious to a skilled person are possible within the scope of the invention.

1. A device for manufacturing products, each product comprising a first component and a second component mutually connected in a determined desired relative position with an accuracy to within less than 50 micrometres, wherein the device comprises:
a plurality of assemblies, each assembly comprising:
a first holder configured and suitable for holding a first component;
a second holder configured and suitable for holding a second component; and
coupling means configured and suitable for mutually coupling the first holder and the second holder such that the first holder and the second holder can move relative to each other within a determined range to a relative position in which a first component held by the first holder and a second component held by the second holder are in the determined desired relative position and the first holder and the second holder can then be temporarily secured and fixed in the relative position;
a first actuator configured configured and suitable for moving the first holder and the second holder relative to each other within the determined range to the relative position; and
connecting means configured and suitable for mutually connecting the first component and the second component the determined desired relative position.

2. The device according to claim 1, wherein at least one of the two components is of an optical nature.

3. The device according to claim 1, wherein the first holder and the second holder) are coupled releasable to each other by means of the coupling means.

4. The device according to claim 1, wherein the coupling means can be of an electrical, magnetic, pneumatic, hydraulic or mechanical nature.

5. The device according to claim 1, wherein the coupling means comprised at least one coupling member.

6. The device according to claim 1, wherein the coupling means also comprises at least one securing member configured and suitable for engaging on the at least one coupling member such that the first holder and the second holder are secured and fixed in the relative position.

7. The device according to claim 1, wherein at least one coupling member is flexible.

8. The device according to claim 1, wherein the coupling means comprise a plurality of coupling members and at least one securing member is configured and suitable for simultaneously engaging on the plurality of coupling members.

9. The device according to claim 1, wherein each assembly also comprises an energy buffer configured and suitable for storing energy and supplying energy to the coupling means.

10. The device according to claim 1, wherein the energy buffer is of an electrical, magnetic, pneumatic, hydraulic or mechanical nature.

11. A method for manufacturing products, wherein each product comprises a first component and a second component mutually connected in a determined desired relative position with an accuracy to within less than 50 micrometres, wherein the method comprises the steps of:
holding a first component by means of a first holder provided for this purpose;
holding a second component by means of a second holder provided for this purpose;
mutually coupling the first holder and the second holder by means of coupling means provided for this purpose, such that the first holder and the second holder can move relative to each other within a determined range to a relative position in which the first component held by the first holder and the second component held by the second holder are in the determined desired relative position;
moving the first holder and the second holder relative to each other within the determined range to the relative position by means of a first actuator provided for this purpose;
temporarily securing and fixing the first holder and the second holder in the relative position by means of the coupling means; and
mutually connecting the first component and the second component in the determined desired relative position by means of connecting means provided for this purpose.

12. The method according to claim 11, wherein the coupling means comprise at least one coupling member and also at least one securing member, wherein the method comprises of engaging on at least one coupling member by means of the at least one securing member such that the first holder and the second holder are secured and fixed in the relative position.

13. The method according to claim 12, wherein the coupling means comprise a plurality of coupling members, wherein the method comprises of engaging simultaneously on the plurality of coupling members means of the at least one securing member.

14. The method according to claim 11, wherein the first holder, the second holder and the coupling means form part of an assembly, which assembly also comprises an energy buffer, wherein the method also comprises of storing energy and supplying energy to the coupling means by means of the energy buffer.

15. The method according to claim 11, wherein the mutual connecting of the first component and the second component in the determined desired relative position comprised of gluing, welding, soldering or connection by means of a laser technique.
